(19) United States
(12) Patent Application Publication
(10) Pub. No.: US 2004/0089165 A1
(43) Pub. Date: May 13, 2004

(54) Tamper-evident closure for liquid containers and bulk containers

(76) Inventor: Fritz Seelhofer, Lindau (CH)

Correspondence Address: Pauley Petersen, Kinne & Erickson, Suite 365, 2800 West Higgins Road, Hoffman Estates, IL, 60195, US

(21) Appl. No.: 10/250,735

(22) PCT Filed: Jan. 4, 2002
(86) PCT No.: PCT/CH02/00002

(30) Foreign Application Priority Data
Jan. 5, 2001 (CH) 7/01

(51) Int. Cl. A23B 4/08; A23B 4/12; B02B 3/12

(52) U.S. Cl. 99/516; 99/534

(57) ABSTRACT

The guarantee closure consists of a closure body (1) with a guarantee foil (4) and with a pour-out spout (2) as well as a closure cap (3) fitting onto the closure body (1). The pour-out spout (2) is arranged on the closure body (1) such that it may be pivoted up. The guarantee foil (4) by way of pivoting-up the pour-out spout (2) into the pour-out position is cut open and thus frees the passage to the pour-out spout. The closure body (1) comprises a relief (11) for receiving tile guarantee foil (4) and forms above this relief (11) by way of two shoulders (12, 13) arranged over one another and distanced from one another a free space (14) for receiving the lying pour-out spout (2). This is enclosed and held by a film-hinge-like material bridge (5) which in the lying condition connects the two shoulders (12, 13) with a surface which seen from the outside is concave and on the upper side of the lying pour-out spout (2) runs together to a point which defines the pivoting axis of the pour-out spout (2). On pivoting up the pour-out spout (2) the film-hinge-like material bridge (5) snaps into a permanent shape which is convex seen from the outside and thus now holds the pour-out spout (2) in the closure position.

This invention relates to a guarantee closure for fluid containers or free-flowing material containers for packaging things like salt, sugar and similar free-flowing or pourable substances. It is the case of a guarantee closure since on opening for the first time a guarantee foil or the packaging skin itself must be cut open.

Many closures of foodstuff containers and bottles as also closures for containers for cleaning agents or any types of liquids such as lubrication oils, chemicals and likewise are designed as guarantee closures. If the closure lid is removed the contents still remains hermetically sealed until a guarantee seal formed as a sealing foil is separately pierced or removed.

As an example of such a guarantee closure there may serve a widely known plastic closure with a closure body and associated lid, as is used for ketchup bottles. The closure body comprises a pour-out spout directed upwards and on its lower side there is located an aluminium foil which here is applied in or adhesed on and acts as a guarantee seal or guarantee closure. If a new bottle is opened for the first time then in some cases firstly a guarantee strip is removed, whereupon the closure lid is flipped up. The closure lid is designed as a cap and when this cap is snapped shut it encloses a hollow space on the closure body. The closure body for its part is screwed onto the bottle thread. Arranged on this closure body is a pour-out spout which stands upright on the closure body shoulder and which is set free on flipping up the closure cap. This pour-out spout is closed on the lower side by a guarantee closure in the form of an aluminium foil applied below the closure body. Thus before one may pour out ketchup for the first time, this aluminium foil at the lower end of the pour-out spout must be pierced. Conventionally this is done with a sharp object, for example with the tip of a knife. With this there however lies the disadvantage that the foil is not cleanly cut away along the inner edge of the spout, but rather is irregularly torn to a greater or lesser extent. Individual brows of the aluminium foil may subsequently still project into the pour-out spout or even released from the aluminium foil may come out with the contents on pouring out. For opening such a closure or its guarantee foil for the first time therefore an additional tool, such as a knife or a needle must be used. Furthermore this opening of the guarantee foil is not effected systematically and in a such technically clean manner which would ensure a complete release of the flow cross section of the pour-out spout.

With the fluid container it does not need be the case of a bottle but also a cardboard carton as is practised for all types of fruit juices, lemonades, fresh water, tea and milk products. Cardboard cartons are furthermore also used for packaging free-flowing material such as sugar, salt and likewise. With these cardboard cartons there is always the problem of how the cardboard carton is opened at the location where the closure is seated. With these cardboard cartons specifically it is the cardboard itself which assumes the role of the guarantee foil and the cardboard carton therefore after opening or on opening the closure must by pierced or cut open, which until now had to be effected by a separate working step and often was only to be accomplished with the help of tools.

It is therefore the object of the present invention to provide a guarantee closure for liquid and free-flowing containers which overcomes the above mentioned disadvantages and with which on opening the closure for the first time the guarantee foil is cleanly opened and at the same time it is ensured that the cross section of the pour-out spout is set free and also remains held free.

This object is achieved by a guarantee closure for a liquid and free-flowing material container, consisting of a closure body with a pour-out spout arranged lying therein in the initial position but which may be pivoted up out of this position and which with respect to the closure body is sealingly enclosed by a film-hinge-like material bridge which on pivoting up the pour-out spout springs from a concave into a convex shape and vice-versa and by way of this retains the pour-out spout in the end positions of its pivoting range, as well as with an associated guarantee foil which in the lying position of the pour-out neck extends below and along this and which is characterised in that the pivoting axis on the pour-out neck lies at such a location that its rear section on pivoting up the pour-out neck pivots downwards, that the rear end of the pour-out neck tapers into a tip which at the beginning of the pivoting-up movement of the pour-out neck tears open the guarantee foil extending below the pour-out neck, and that the pour-out neck on that side which faces the guarantee foil forms a wedge-shaped cut-edge which on pivoting up the pour-out neck cuts open the guarantee foil.

Advantageous embodiments of this guarantee closure are shown in the drawings in various positions and are explained in detail in the subsequent description. By way of these drawings the function of the closure is also explained.

There are shown in

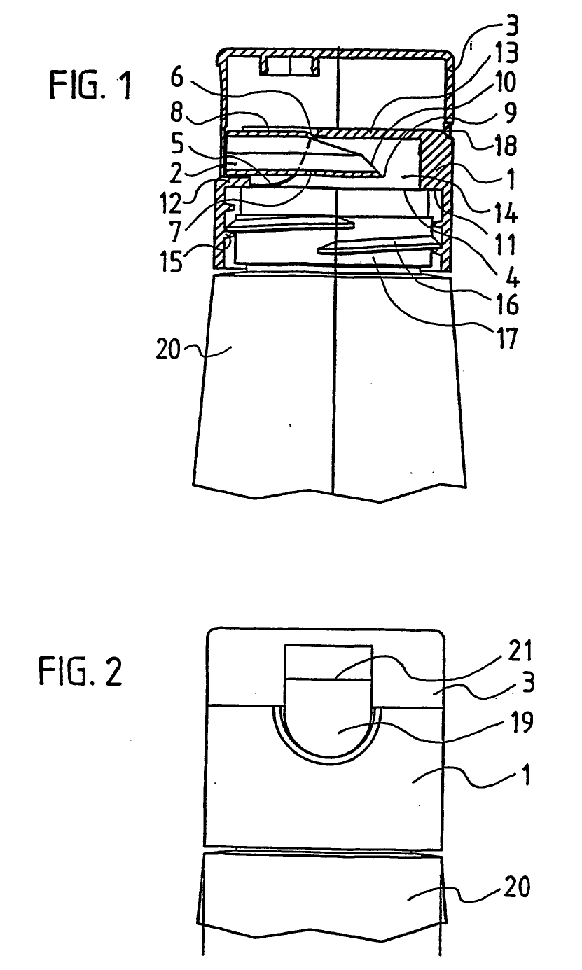

FIG. 1 the guarantee closure in the longitudinal section, placed onto a bottle, in the closed position before first use of the bottle;

FIG. 2 the closed guarantee closure in a view from the front, that is to say from the left in FIG. 1;

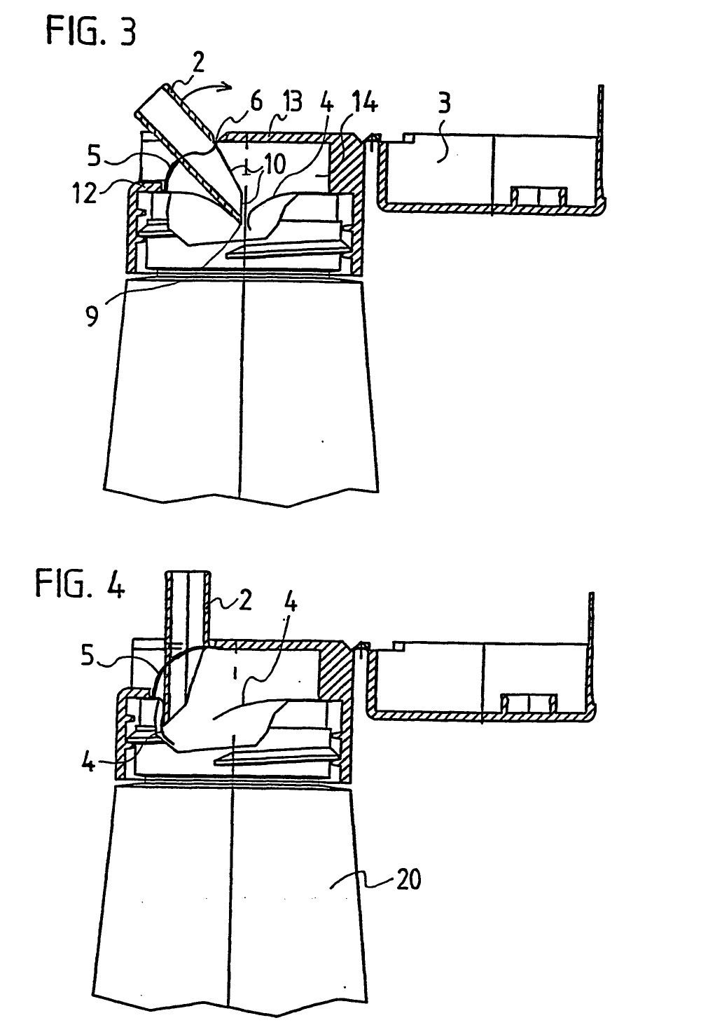

FIG. 3: the guarantee closure in a longitudinal section with a flipped-up closure cap, with the pour-out spout, on pivoting up, and simultaneous cutting open the guarantee foil;

FIG. 4: the guarantee closure in a longitudinal section with a flipped-up closure cap, with the pour-out spout pivoted completely into the pour-out position after cutting-open the guarantee foil;

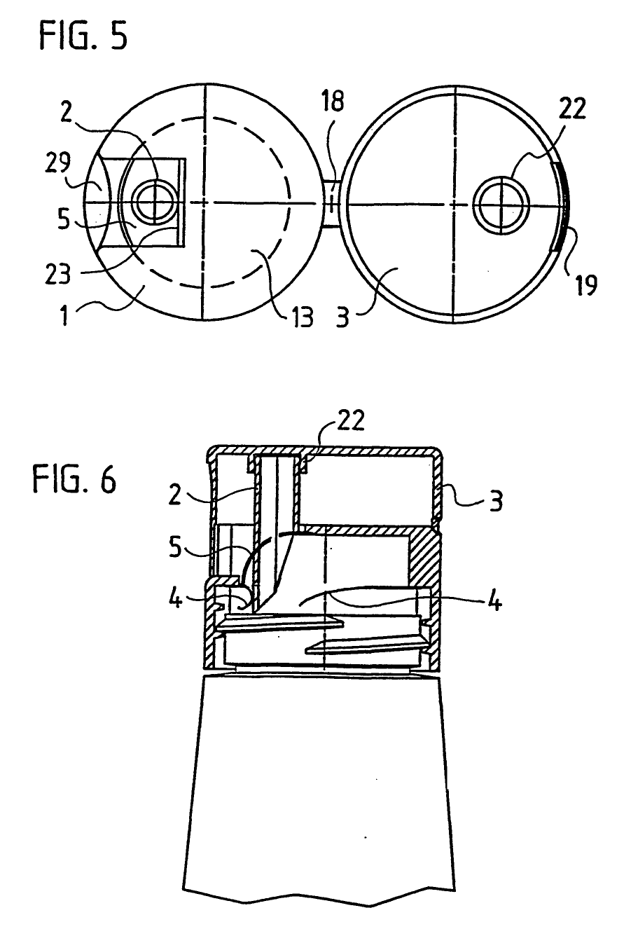

FIG. 5 the guarantee closure with a flipped-up closure cap, with the pour-out spout in the pour-out position and a cut-open guarantee foil, seen from above;

FIG. 6: the guarantee closure in a longitudinal section with a closure cap which has been flipped shut again, with the pour-out spout remaining in the pour-out position after the use for the first time;

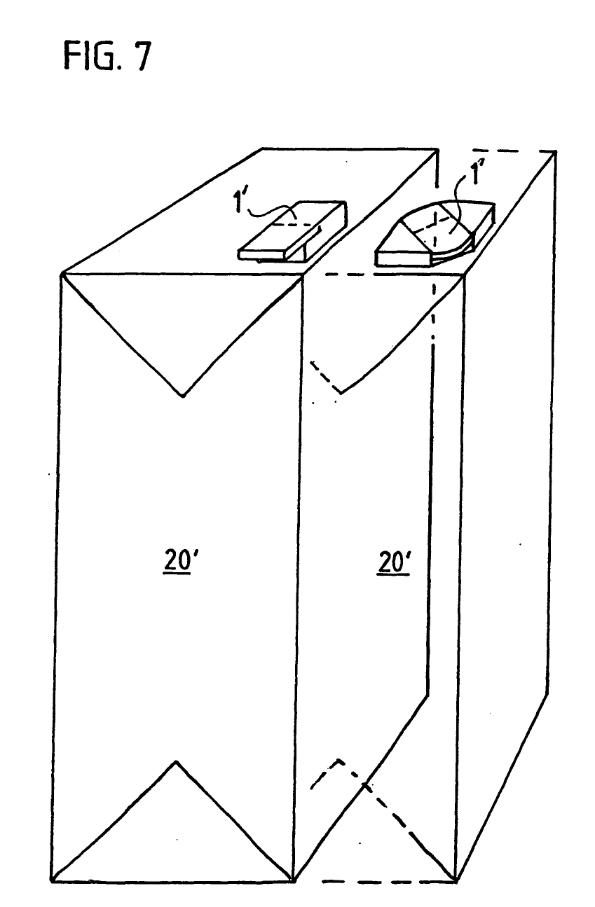

FIG. 7: a variant of the guarantee closure for a fluid and free-flowing material container in the form of a cuboid cardboard carton, left for pouring out the contents via a narrow side, and on the right next to this for pouring out the contents via a corner of the cuboid container;

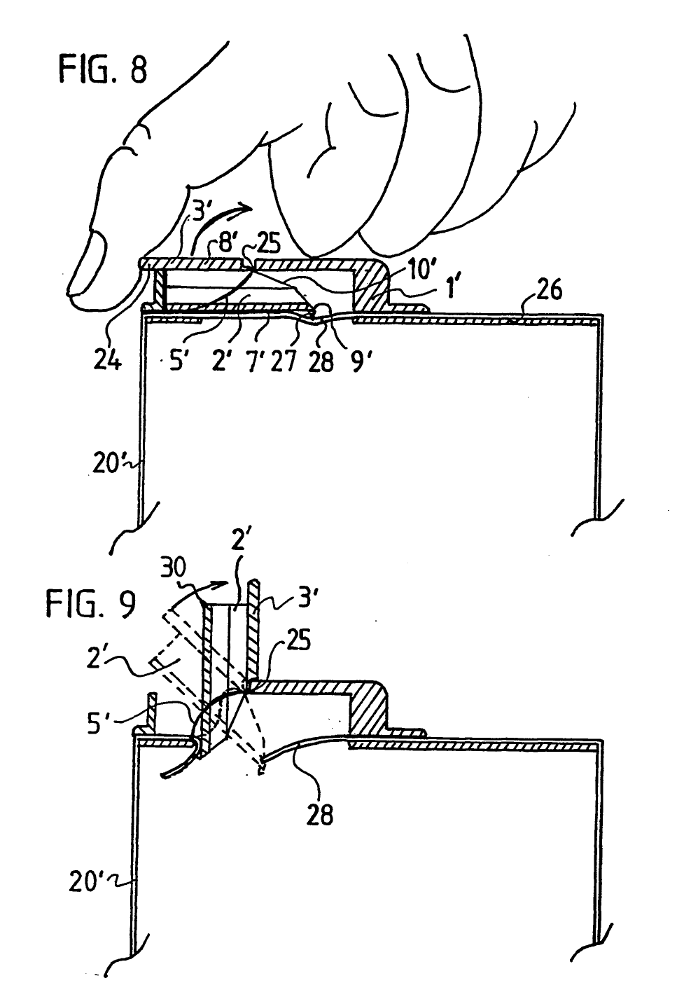

FIG. 8: the guarantee closure according to FIG. 7 on the left in a longitudinal section seen from the side before pivoting up the pour-out spout;

FIG. 9 the guarantee closure according to FIG. 8 after pivoting up the pour-out spout into the pour-out position and after the effected piercing and cutting open of the cardboard carton upper side acting as a guarantee foil.

FIG. 1 shows the guarantee closure in a longitudinal section along the axis of the bottle 20 which here however is only indicated. It consists of a closure body 1, of a pour-out spout 2 and of a closure cap 3 fitting the closure body 1. This closure cap 3 here is connected to the closure body 1 as one piece so that it may be flipped up on it. It is however also conceivable to manufacture the closure cap 3 as a separate piece, wherein it then is either equipped with snap-closures so that it may be stuck onto the closure body, or however also that it is equipped with an inner thread and thus may be screwed onto a fitting outer thread on the closure body 1. The closure body 1 on the lower side forms a relief 11 extending allround on which there is applied or adhesed a guarantee foil 4. This guarantee foil 4 ensures that the closure hermetically seals the container or the bottle 20 and simultaneously ensures that he who opens the closure the first time is also indeed the first who may remove fluid out of the container or the bottle 20. In the example shown here the closure body 1 by way of an inner thread 15 is screwed onto the outer thread 16 on the bottle neck 17 of this bottle 20. The thing special about this guarantee closure is now that the pour-out spout 2 is arranged on the closure body 1 such that it may be pivoted up, wherein the guarantee foil 4 by way of pivoting up the pour-out spout 2 in its pour-out position by way of this itself is automatically cut open. For this the pour-out spout 2 as may be easily seen here is held lying between two shoulders 12, 13 which are formed on the closure body 1 and arranged over one another at a distance to one another. To be more exact the pour-out spout 2 is held by a film-hinge-like material bridge 5 which sealingly encloses the whole pour-out spout 2 and connects the two shoulders 12, 13 on the closure body 1. In the FIG. 1 which indeed shows the guarantee closure before its first opening, the pour-out connection piece 2 is accommodated lying in the free space 14 which is limited above and below by the two shoulders 12, 13 of the closure body 1, as well as laterally by its wall which stands perpendicular to the shoulders. In this position of the pour-out spout 2 the film-hinge-like material bridge 5 seen from the outside, that is to say from the left, forms a concave surface. Above the pour-out spout 2 where the material bridge 5 enclosing the pour-out spout 2 runs together, the point 6 forms a rotation axis 6 for the pour-out spout 2. As one can see the pour-out spout 2 on its here lower side 7, towards the right, thus towards that end which is to be pivoted towards the container 20, is longer than on the upper side 8 and here tapers into a tip 9. Thus from its walling there are formed two edges 10 which taper at an askew angle to this tip 9. These outer edges 10 act as cutting edges as will be clear later.

Below FIG. 1 there is shown the guarantee closure by way of FIG. 2 in a view from the front, wherein here one sees it from the left side of FIG. 1. The closure cap 3 comprises a tongue 19 which extends downwards and overlaps the closure body 1 at this location. This tongue 19 is advantageously via a thin location 21 set off somewhat from the remaining material of the closure cap 3 so that it may be slightly pivoted to the outside somewhat and may be gripped with two fingers. For opening the closure one grips this tongue 19 on the closure cap 3 and pivots up the closure cap 3 onto the closure body 1 lying thereunder about its hinge connection 18 arranged on the rear side.

FIG. 3 shows the guarantee closure in a longitudinal section with a closure cap 3 which in this manner has already been flipped up. By way of this figure there is now to be explained the pivoting-up of the pour-out spout 2 and the cutting-open of the guarantee foil 4 which is effected at this same time. Specifically with two fingers one grips the front part of the pour-out spout 2 which projects out of the material bridge 5 and pivots this up about the rotational axis 6 in the direction of the drawn arrow. The pour-out spout 2 by way of pressing the thumb onto its opening and afterwards a pivoting movement of the thumb out of its lying position, may also be pivoted up about the rotation axis 6. As is drawn in here at the same time the tip 9 of the lower end of the pour-out spout 2 tears a hole into the guarantee foil 4, and with a further pivoting up of the pour-out spout 2 the edges 10 cut further on both sides of the created hole so that out of the guarantee foil 4 a strip is cut out which is bent back by the further pivoting pour-out spout 2. FIG. 3 shows this pivoting-up movement during which the cutting-open of the guarantee foil 4 is effected, to half the path to be covered.

FIG. 4 shows the completion of this movement. Now the pour-out spout 2 has reached its pour-out position and the guarantee foil 4 is adequately cut open so that it sets free the cross section of the spout 2 and this also remains since the cut-open strip of the guarantee foil 4 is held back from the lower end of the pour-out spout 2. During the pivoting up of the pour-out spout 2 the film-hinge-like material bridge 5 has deformed. At the same time it had to overcome a dead centre. On overcoming this dead centre the material bridge 5 snaps from a shape which seen from the outside is firstly concave under which it developed a spring tension which kept the pour-out spout 2 in the lying position, now into a convex shape, under which it develops a spring tension in the direction of the pivoting-up of the spout 2, and therefore keeps it in the pour-out position which has been once assumed. The guarantee closure is now open and the bottle 20 is ready for pouring out its contents.

In FIG. 5 this position of the guarantee closure with a flipped-up closure cap 3 and with the pour-out spout 2 in the pour-out position and cut-open guarantee foil is shown seen from above. As one recognises here on the closure body 1 on its front side a concavity 29 is taken out which simplifies with a closed closure cap 3 the gripping of the tongue 19 overlapping this. The material 5 which seen from above surrounds the pour-out spout 2 belongs to the film-hinge-like material bridge 5 which here thus is curved convexly outwards and on account of its spring tension from now keeps the spout 2 in the pour-out position 2. The upper shoulder 13 of the closure body 1 forms a recess 23, within which this material bridge 5 sealingly encloses the pour-out spout 2 so that thus the inside of the bottle exclusively communicates with the outside of the bottle. With an interrupted line the inner diameter of the closure body 1 is drawn in, over which the guarantee foil extends. This however in the condition shown here is already cut open and displaced to the side even if not visible here. On the inner side of the closure cap 3 one sees a collar 22. This is envisaged for enclosing the opening edge of the pour-out spout 2 with the re-closed condition of the closure, so that this firstly is sealingly closed and secondly the position of the pour-out connection 2 is additionally secured.

FIG. 6 shows finally this guarantee closure in a longitudinal section with a closure cap 3 which has been re-closed, with the pour-out spout 2 remaining in the pour-out position after use for the first time. Here one may see very well how the collar 22 on the closure cap 3 encloses the opening edge of the pour-out spout 2. The film-hinge-like material bridge 5 remains in its shape which is convex seen from the outside, and the lower end of the pour-out spout 2 presses the cut open guarantee foil 4 further to the side and thus keeps the pour-out free.

In FIG. 7 the guarantee closure is shown in an application on a cardboard fluid carton or a cardboard free-flowing material carton, and specifically in the figure left for pouring out the contents via a narrow side of the packaging carton and in the figure to the right next to this for pouring out the contents via a corner of the packaging carton. Such cardboard packagings are applied for all sorts of fruit juices, lemonades, fresh water, tea and milk products, in many ccountries even wine. Furthermore also free-flowing material contents such as sugar and salt and similar products are packaged in such cardboard cartons. Instead of a circular shape as is shown in the FIGS. 1 to 6 the guarantee closure shown here has in the example on the left a rectangular base shape and in the variant for building in the corner of a cardboard carton a boat-like base shape. The arranging of the closure in the corner is advantageous because then the contents which indeed runs better together here, may be emptied from the carton without any remains. Further base shapes of the closure are conceivable according to the particularities and the shaping of the packaging. The guarantee closure 1′ may be adhesed onto the cardboard carton 20′ or be connected sealingly to the cardboard carton 20′ by way of an ultrasound welding. In this case a plastic foil is applied below the upper closure surface of the cardboard carton and the closure then with the inclusion of the cardboard carton closure surface is welded to the plastic foil applied thereunder at least at locations by way of an ultrasound welding.

As one can see from FIG. 8 the closure cap 3′ is here formed as a flat lid and overlaps the closure body to the front, that is to say to the left in the drawing, whilst the closure cap hinge 25 is arranged roughly in the middle of the closure length. The front part of the lid may therefore be pivoted upwards about the hinge axis 25 which is drawn in with the arrow, for which the closure cap 3′ at its front, projecting edge 24 may be gripped. Most simply one places the thumb below the edge 24 of the closure cap 3′, as is shown in the picture, and then pulls it up. As one further recognises in the drawing on the lower side of the upwardly pivotable closure cap there is formed a pour-out spout 2′. This on its rear side or the lower side in the pivoted up condition is chamfered and thus tapers towards that end which on pivoting-up is pivoted towards the container 20′ into a tip 9′. Thus from its walling there are formed two edges 10′ which taper at an askew angle to this tip 9′. Pointing downwards as is shown here on the tip 9′ there may be formed a perforating tip 27. This may be formed by a plastic cone pointing downwards with the tip, wherein the tip of the cone may taper into a sharp, short needle, or the perforating tip is formed by a large-surfaced plastic triangle aligned along the pour-out spout axis, with a sharp tip. The lower rear longitudinal side 7′ of the pour-out spout 2′ is formed into a sharp, wedge-shaped longitudinal edge which may act as a cutting edge, as will yet be explained. Below the closure there extends the cardboard of the liquid or loose material carton and by the tip 27 is pressed slightly downwards. The closure is from above glued onto the cardboard carton or connected to a plastic foil 26 applied below the cardboard by way of ultrasound welding.

FIG. 9 shows how the closure functions. Firstly with one finger, best of all the thumb the closure lid 3′ at its edge 24 is gripped and flipped up about the hinge axis 25, by which means simultaneously the pour-out spout 2′ arranged on the lower side of the closure lid 3′ is pivoted by 900 into the vertical position. On the outside between the pivotable pour-out spout 2′ and the closure housing 1′ there is located a thin sealing membrane 5′ in the shape of a film-hinge-like material bridge which in the initial position with a lying pour-out spout 2′ as shown in FIG. 8 seen from the outside, that is to say seen from the left in the drawing, is curved concavely. On pivoting up the closure cap 3′ and the pour-out spout 2′ formed thereon this membrane 5′ springs into a convex shape and develops in this position a force in~the direction of the pivoting-up of the pour-out spout 2′. Because the pivoting axis is arranged roughly in the middle of the length of the pour-out spout 2′ on pivoting up this, its rear, specially formed part flips downwards. At the same time the perforating tip 27 presses on the cardboard of the liquid carton 20′ and here tears a hole in this. This is extremely important since only proceeding from such a tear location may the thick cardboard 28 be cut open further. On flipping up the pour-out spout 2′ the lower wedge-shaped longitudinal edge of the pour-out spout 2′ presses onto the tear location and this lower edge on the spout 2′ acting as a knife cuts open the cut-open hole even more so that the lower part of the pour-out spout 2′ finally projects into the inside of the cardboard carton 20′ and this is opened. In FIG. 9 for an improved understanding a middle pivot position of the closure lid 3′ and pour-out spout 2′ is shown dashed. Finally the pour-out spout 2′ reaches the vertical position in which the sealing membrane 5′ seen from the outside is convexly curved and retains the pour-out spout 2′ in this position. If the pour-out spout 2′ after pouring out the desired liquid quantity is pivoted down again, the membrane 5′ springs again into its concave shape and retains the spout 2′ in the lying position. So that the fluid contents may be poured out cleanly, the edge of the pour-out spout 2′ may be equipped with a drip lug 30.

1. A guarantee closure for a liquid and free-flowing material container (20, 20′) consisting of a closure body (1) with a pour-out spout (2, 2′) arranged lying therein in the initial position but which may be pivoted up out of this position and which with respect to the closure body (1) is sealingly enclosed by a film-hinge-like material bridge (5,5′) which on pivoting up the pour-out (2, 2′) spout springs from a concave into a convex shape and vice-versa and by way of this retains the pour-out spout (2, 2′) in the end positions of its pivoting range, as well as with an associated guarantee foil (4, 28) which in the lying position of the pour-out spout (2, 2′) extends below and along this, characterised in that the pivoting axis on the pour-out spout (2, 2′) lies at such a location that its rear section on pivoting-up the pour-out spout (2, 2′) pivots downwards, that the rear end of the pour-out spout (2, 2′) tapers into a tip (9, 9′) which at the beginning of the pivoting-up movement of the pour-out spout (2, 2′) tears open the guarantee foil (4, 28) extending below the pour-out spout (2, 2′), and that the pour-out spout (2, 2′) on that side which faces the guarantee foil (4, 28) forms a wedge-shaped cut-edge which on pivoting up the pour-out spout (2, 2′) cuts open the guarantee foil (4, 28).

2. A guarantee closure for a liquid and free-flowing material container (20, 20′) according to claim 1, characterised in that pour-out spout (2′) at its end (9′) comprises a perforating tip (27) which is formed out of a plastic cone pointing to the guarantee foil (28).

3. A guarantee closure for a liquid and free-flowing material container (20, 20′) according to claim 1, characterised in that the pour-out spout (2′) at its end (9′) comprises a perforating tip (27) which is formed by a large-surfaced plastic triangle directed along the pour-out spout axis, with a sharp tip.

4. A guarantee closure for a fluid and free-flowing material container (20, 20′) according to one of the preceding claims, characterised in that the pour-out spout (2, 2′) on its lower, rear longitudinal side forms a sharp, wedge-shaped longitudinal edge which on pivoting up the pour-out spout (2, 2′) is envisaged to act as a cutting edge.

5. A guarantee closure for a fluid and free-flowing material container (20, 20′) according to one of the preceding claims, characterised in that the pour-out spout (2, 2′) in its position lying in the closure body (1) on its lower side (7, 7′) in the direction of its end (9, 9′) to be pivoted towards the container (20, 20′) is longer that on its upper side (8, 8′), so that it at this end tapers at an askew angle to the axis of the pour-out spout (2, 2′) into a tip (9, 9′) and the edges (10, 10′) tapering at an askew angle to the lower end (9, 9′) of the pour out spout (2, 2′) are formed as cutting edges.

6. A guarantee closure for a liquid and free-flowing material container (20) according to one of the preceding claims, characterised in that the closure body (1) comprises a relief (11) for receiving the guarantee foil (4), and above this relief (11) by way of two shoulders (12,13) arranged over one another and distanced from one another forms a free space (14) for receiving the lying pour-out spout (2), wherein this pour-out spout (2) is enclosed by a film-hinge-like material bridge (5) which in the lying condition connects the two shoulders (12, 13) with a surface which is concave seen from the outside and on the upper side of the lying pour-out spout (2) runs together to a point which defines the pivoting axis (6) of the pour-out spout (2).

7. A guarantee closure for a liquid and free-flowing material container (20) according to one of the preceding claims, characterised in that the closure cap (3) on its inner side has a collar (22) formed on, which is envisaged for receiving the upper edge of the pivoted-up pour-out spout (2), and that the closure cap (3) via a film hinge (18) is connected as one piece to the closure body (1) and in the closure position may be locked onto the closure body (1).

8. A guarantee closure for a liquid and free-flowing material container (20) according to one of the claims 1 to 6, characterised in that the closure cap (3) on its inner side has a collar (22) formed on, which is envisaged for receiving the upper edge of the pivoted-up pour-out spout (2) and that the closure cap (3) by way of a snap closure may be stuck onto the closure body (1), or by way of an inner thread may be screwed onto the closure body with an outer thread.

9. A guarantee closure for a liquid and free-flowing material container (20) according to one of the preceding claims, characterised in that the closure body (1) is equipped with an inner thread (15), by way of which it may be screwed onto the outer thread (16) of a bottle neck (17).

10. A guarantee closure for a liquid and free-flowing material container (20) according to one of the preceding claims, characterised in that the upper shoulder (13) of the closure body (1) comprises a recess (23) within which the pour-out spout (2) is sealingly enclosed by the film-hinge-like material bridge (5).
